(19) United States
(12) Patent Application Publication
(10) Pub. No.: US 2008/0309217 A1
(43) Pub. Date: Dec. 18, 2008

(54) ORGANIC LIGHT EMITTING DEVICES

(76) Inventors: Carlijn L. Mulder, Boston, MA (US); Kemal Celebi, Cambridge, MA (US); Marc Baldo, Cambridge, MA (US)

Correspondence Address: LOWRIE, LANDO & ANASTASI, LLP, ONE MAIN STREET, SUITE 1100, CAMBRIDGE, MA, 02142, US

(21) Appl. No.: 12/122,107

(22) Filed: May 16, 2008

Related U.S. Application Data
(60) Provisional application No. 60/938,964, filed on May 18, 2007.

(51) Int. Cl. H01J 1/62; H01J 9/02

(52) U.S. Cl. 313/498; 445/35

(57) ABSTRACT

A light emitting device comprising an emissive material optically coupled to a device that is constructed and arranged to pass an emission wavelength of the emissive material and eliminate angular dependence of the emission wavelength is provided.

### PRIORITY APPLICATION

This application claims priority to, and the benefit of, U.S. Provisional Application No. 60/938,964 filed on Mar. 18, 2007, the entire disclosure of which is hereby incorporated herein by reference for all purposes.

### GOVERNMENT SPONSORED RESEARCH

Certain embodiments disclosed herein were made with Government support under a grant from the National Science Foundation (Grant No. 6897058). The Government may have certain rights.

### FIELD OF THE TECHNOLOGY

Embodiments of the technology disclosed herein relate generally to light emitting devices. More particularly, certain embodiments disclosed herein are directed to a light emitting device comprising an emissive material optically coupled to a device that is constructed and arranged to pass an emission wavelength of the emissive material and reduce or eliminate angular dependence of the emission wavelength.

### BACKGROUND

Light emitting devices can have an angular dependence for their color emission. That is, as the viewing angle changes, the emitted color of the light emitting device may also change. This change is undesirable as it can affect the fidelity of color production in devices such as displays.

### SUMMARY

In accordance with a first aspect, a light emitting device comprising an emissive material optically coupled to a device constructed and arranged to pass an emission wavelength of the emissive material and eliminate angular dependence of the emission wavelength.

In certain examples, the light emitting devices comprises a first electrode and a second electrode, and the emissive material is between the first electrode and the second electrode. In some examples, the composition of the first and second electrodes may be selected to provide a strong microcavity. In other examples, the first electrode may be between the emissive material and the device constructed and arranged to pass an emission wavelength of the emissive material and eliminate angular dependence of the emission wavelength. In some examples, the device constructed and arranged to pass an emission wavelength of the emissive material and eliminate angular dependence of the emission wavelength may be an opal diffuser or a holographic diffuser or both. In some examples, the emissive material may be a phosphor. In certain examples, the light emitting device may further comprise a hole transport layer between the first electrode and the emissive material. In other examples, the light emitting device may further comprise an electron transport layer between the second electrode and the emissive material. In some examples, the light emitting device may comprise a hole transport layer between the first electrode and the emissive material and an electron transport layer between the second electrode and the emissive material.

In accordance with another aspect, a method of providing a light emitting device is disclosed. In some examples, the method comprises providing a first electrode, a second electrode, and an emissive material between the first electrode and the second electrode, and providing a device configured to optically couple to the emissive material and to pass an emission wavelength of the emissive material and substantially eliminate angular dependence of the emission wavelength.

In certain examples, the method may further comprise applying a voltage across the first electrode and the second electrode of the light emitting device to provide emission from the emissive material. In some examples, the method may further comprise configuring the first electrode to be biased by an energy source to provide electrons. In other examples, the method may further comprise providing an electron transport layer between the first electrode and the emissive material. In additional examples, the method may also comprise providing a hole transport layer between the second electrode and the emissive material.

In accordance with another aspect, a light emitting device comprising a first electrode, a second electrode; an emissive material disposed between the first electrode and the second electrode; and a device optically coupled to the emissive material and configured to pass an emission wavelength from the emissive material that is substantially independent of viewing angle. In some examples, the light emitting device may further comprise a hole transport layer between the first electrode and the emissive material. In other examples, the light emitting device may comprise an electron transport layer between the second electrode and the emissive material. In certain examples, the light emitting device may further comprise an electron transport layer between the second electrode and the emissive material.

In accordance with an additional aspect, a light emitting device comprising a strong microcavity optically coupled to a device configured to provide a Lambertian emission profile is disclosed.

In accordance with another aspect, a light emitting device comprising a strong microcavity optically coupled to a device that is constructed and arranged to emit light without any substantial angular color shift is provided.

Additional features, aspects, examples and embodiments are possible and will be recognized by the person of ordinary skill in the art, given the benefit of this disclosure.

### BRIEF DESCRIPTION OF THE FIGURES

Certain illustrative embodiments are described below with reference to the figures in which:

FIG. 1 is a first illustration of a light emitting device, in accordance with certain examples;

FIG. 2 is another illustration of a light emitting device, in accordance with certain examples;

FIG. 3 is an example of a light emitting device, in accordance with certain examples;

FIG. 4 is an embodiment of a light emitting device, in accordance with certain examples;

FIG. 5(a) are structural schematics of a strong and a weak microcavity organic light emitting device (OLED) structure, and FIG. 5(b) shows a comparison of the coupling efficiency of the strong and weak microcavities, in accordance with certain examples;

FIG. 6(a) shows the quantum efficiency of the devices of Example 1, and FIG. 6(b) shows the percent transmission of the devices of Example 1, in accordance with certain examples;

FIG. 7(a) and FIG. 7(b) show the electroluminescence spectra as a function of angle from the surface normal for the strong microcavity OLED with (FIG. 7(a)) and without the holographic diffuser (FIG. 7(b)), and FIG. 7(c) shows the color coordinates for the devices, in accordance with certain examples;

FIG. 8(a) is an angular profile of electroluminescence from the strong microcavity OLED, in accordance with certain examples;

FIG. 8(b) is a scanning electron micrograph of the surface of the holographic diffuser, in accordance with certain examples; and

FIG. 8(c) is a scanning electron micrograph of a cross-section of a holographic diffuser, in accordance with certain examples.

It will be recognized by the person of ordinary skill in the art, given the benefit of this disclosure, that the dimensions of certain elements in the figures may have been enlarged, distorted or otherwise shown in a non-conventional manner to provide a more user-friendly description of the technology. In particular, the relative thicknesses of the different components in the light emitting devices should not be limited by the figures.

### DETAILED DESCRIPTION

In accordance with certain examples, embodiments of the light emitting devices disclosed herein provide significant advantages over existing devices including, for example, more saturated emission colors and reduced angular dependence of the emission wavelength.

The realization of stable blue phosphorescent organic light emitting devices (OLEDs) has proved challenging. An important limitation is the broad photoluminescent (PL) spectrum characteristic of organic dyes. For example, greenish-blue or ‘sky-blue’ phosphors have strong emission in the blue.¹ But optical transitions to higher vibrational modes of the electronic ground state extend their emission spectrum deep into the green. Because the eye responds strongly at green wavelengths, this broad emission spectrum yields an unsaturated color that is ill suited for most display applications. Unfortunately, increasing the energy of a sky-blue phosphor to minimize its green emission requires strong confinement of excited states in the host and dye,² limiting the molecular design possibilities. In contrast, the triplet state of a sky-blue phosphor is compatible with a broader range of host materials and sky-blue phosphors have achieved lifetimes exceeding 15,000 hours at an initial brightness of 200 cd/m².³

The color of a dye can be modified by inserting it within a microcavity.^{4,5} In a conventional OLED, weak reflections from interfaces form a microcavity. But the effects of a weak microcavity on the electroluminescence (EL) are relatively minor.⁶ In a strong microcavity, the dye is positioned between two highly reflective films. A strong microcavity significantly modifies the photonic mode density within the OLED, suppressing EL at undesirable wavelengths, and enhancing EL from the homogeneously broadened phosphor at the microcavity resonance.

Certain embodiments disclosed herein use a strong microcavity, e.g., one having two reflective films, to provide an efficient and saturated blue phosphorescent OLEDs. Certain embodiments are optically coupled to a device that is configured to reduce or remove any angular dependence of the light emission. The usual disadvantages of a strong microcavity, namely the introduction of an angular dependence to the OLED's color, and a non-Lambertian angular emission profile, may be overcome by scattering the emitted radiation using such a device.

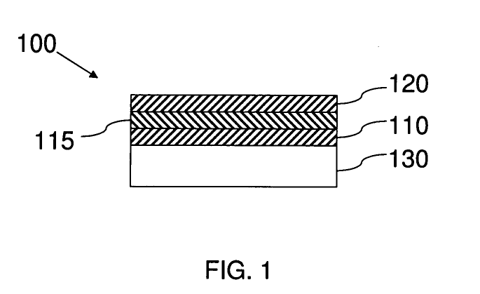

In accordance with certain examples, an illustrative light emitting device is shown in FIG. 1. The device 100 includes a first electrode 110, a second electrode 120, and an emissive material 115 between the first electrode 110 and the second electrode 120. The light emitting device 100 also includes a device 130 optically coupled to the emissive material 115. Though the device 130 is shown in FIG. 1 to abut the first electrode 110, in certain examples the device 130 may abut the second electrode 120 instead. In certain examples, the composition of the first electrode 110 and the second electrode 120 may be selected such that a strong microcavity is provided. For example, the composition of the first electrode 110 and the second electrode 120 may be selected such that reflective films are produced. In some examples, the first and second electrodes may each independently comprise aluminum, silver, magnesium, gold or other conductive materials.

In certain examples, the emissive material may be selected from known materials that emit light by phosphorescence emission after excitation. Illustrative materials include, but are not limited to, iridium(III)bis[(4,6-difluorophenyl)-pyridinato-N,C2′]picolinate (FIrpic), PtOEP, Tr(ppy) 3, FIr6, btpIr, btIr, Tr(piq) 2(acac), In certain examples, the emissive material may be doped into a host material. Illustrative host materials include, but are not limited to, 4,4-N,N-dicarbazolyl-biphenyl (CBP), N,N-bis(3-methylphenyl)-[1,1-biphenyl]-4,4-diamine (TPD), 1,3-bis(9-carbazolyl)benzene (mCP), 4,4,4-tri(N-carbazolyl) triphenylamine (TCTA), BAlq3, and Alq3.

In accordance with certain examples, the device 130 may be, or include, any medium or device that can effectively scatter emitted light to reduce or to eliminate the angular dependence of the emission color. For example, the device 130 may be an opal diffuser, a holographic diffuser or other suitable diffusers. In certain examples, the device 130 may be configured to pass an emission wavelength of the emissive material and eliminate angular dependence of the emission wavelength. In other examples, the device 130 may be constructed and arranged to pass an emission wavelength from the emissive material that is substantially independent of viewing angle and without substantially affecting the color properties, e.g., saturation, hues and the like, of the emitted light. Additional properties and advantages of a device 130 will be readily selected by the person of ordinary skill in the art, given the benefit of this disclosure.

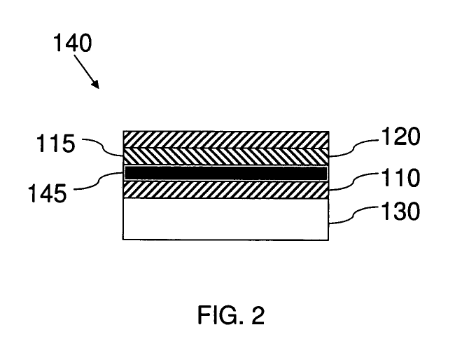

In certain examples, a light emitting device 140 may further comprise a hole transport layer 145 between the first electrode 110 and the emissive material 115, as shown in FIG. 2. In certain examples, the hole transport layer (HTL) may include an organic chromophore. The organic chromophore may be a phenyl amine, such as, for example, N,N′-diphenyl-N,N′-bis(3-methylphenyl)-( 1,1′-biphenyl)- 4,4′-diamine (TPD) or other suitable phenyl amines. The HTL may include a polyaniline, a polypyrrole, a poly(phenylene vinylene), copper phthalocyanine, an aromatic tertiary amine or polynuclear aromatic tertiary amine, a 4,4′-bis(9-carbazolyl)- 1,1′-biphenyl compound, or an N,N,N,N′-tetraarylbenzidine. Additional suitable materials for use in a hole transport layer will be readily selected by the person of ordinary skill in the art, given the benefit of this disclosure.

In some examples, the hole transport layer may be doped with a material to increase or aid in hole injection from the first electrode, e.g., from the anode. In some examples, the dopant may be mixed homogeneously in the hole transport layer, whereas in other examples, the dopant may be concentrated or gradiated such that more of the dopant is closer to the first electrode or further away from the first electrode. Illustrative dopants include, but are not limited to, tetrafluorotetracyanoquinodimethane (F4-TCNQ) and other suitable materials. The dopant may be used for example, to aid hole injection, as there may be a very large barrier for charges from certain materials, e.g., silver, into the organic material. In addition, other techniques to aid hole injection may be used. For examples, the electrodes, contacts of some portion thereof may be treated with a CF4 plasma prior to vacuum deposition of organic layers. Additional suitable techniques will be readily selected by the person of ordinary skill in the art, given the benefit of this disclosure.

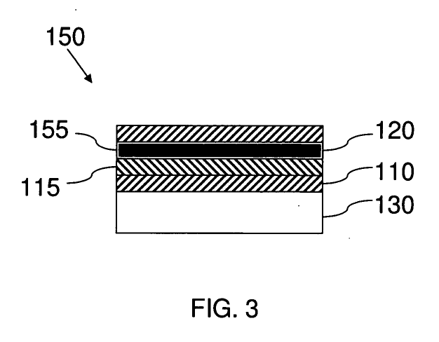

In accordance with certain examples, a light emitting device 150 may include en electron transport layer 155 as shown in FIG. 3. In certain examples, the electron transport layer (ETL) may be a molecular matrix. In certain examples, the molecular matrix may be non-polymeric. In some examples, the molecular matrix may include a small molecule such as a metal complex. For example, the metal complex can be a metal complex of 8-hydroxyquinoline. In certain examples, the metal complex of 8-hydroxyquinoline may be an aluminum, gallium, indium, zinc or magnesium complex, e.g., aluminum tris(8-hydroxyquinoline) (AlQ₃). Other suitable materials for use in the ETL can include, but are not limited to, metal thioxinoid compounds, oxadiazole metal chelates, triazoles, sexithiophene derivatives, pyrazine, styrylanthracene derivatives, bathocuproine (BCP) and bathocuproine (BCP)derivatives. These illustrative materials may be used alone or in combination with any one or more other materials. The person of ordinary skill in the art, given the benefit of this disclosure, will be able to select suitable material for use in electron transport layers.

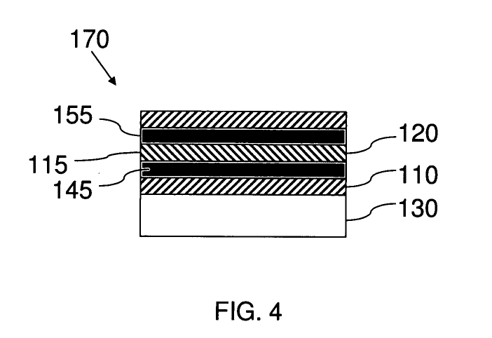

In certain examples, the light emitting device 170 may include a first electrode 110, a second electrode 120, an emissive material 115 between the first electrode and the second electrode, a hole transport layer 145 between the first electrode 110 and the emissive material 115, an electron transport layer 155 between the second electrode 120 and the emissive material 115, and a device 130 abutting the first electrode 110, as shown in FIG. 4. The electrodes, hole transport layer, electron transport layer, emissive material and diffuser may be any one or more of the illustrative materials disclosed herein. The device 130 may be any suitable device that can effectively scatter emitted light to reduce or to eliminate the angular dependence of the emission color.

In accordance with certain examples, the exact thickness of each of the components may vary depending, for example, on the desired properties of the device and/or its intended use. The first electrode may have a thickness of about 500 Angstroms to about 4000 Angstroms. The hole transport layer may have a thickness of about 50 Angstroms to about 1000 Angstroms. The electron transport layer may have a thickness of about 50 Angstroms to about 1000 Angstroms. The second electrode can have a thickness of about 50 Angstroms to greater than about 1000 Angstroms. The thickness of the emissive layer may vary from about 50 Angstroms to about 1000 Angstroms. The thickness of the device 130 may be from about 1000 Angstroms to about 1 mm.

In accordance with certain examples, other multilayer structures may be used to improve the light emitting device performance or to alter the properties of the light emitting device. In certain examples, a blocking layer, such as an electron blocking layer (EBL), a hole blocking layer (HBL) or a hole and electron blocking layer, may be included in the device. Some examples of materials useful in a hole blocking layer or an electron blocking layer include, but are not limited to, 3-(4-biphenylyl)- 4-phenyl-5-tert-butylphenyl-1,2,4-triazole (TAZ), 3,4,5-triphenyl-1,2,4-triazole, 3,5-bis(4-tert-butylphenyl)- 4-phenyl-1,2,4-triazole, bathocuproine (BCP), 4,4′,4″-tris{N-(3-methylphenyl)-N-phenylamino}triphenylamine (m-MTDATA), poly-ethylene dioxythiophene (PEDOT), 1,3-bis(5-(4-diphenylamino)phenyl-1,3,4-oxadiazol-2-yl)benzene, 2-(4-biphenylyl)- 5-(4-tert-butylphenyl)- 1,3,4-oxadiazole, 1,3-bis[5-(4-(1,1-dimethylethyl)phenyl)- 1,3,4-oxadiazol-2-yl]benzene, 1,4-bis(5-(4-diphenylamino) phenyl-1,3,4-oxadiazol-2-yl)benzene, or 1,3,5-tris[5-(4-(1,1-dimethylethyl)phenyl)- 1,3,4-oxadiazol-2-yl]benzene.

In accordance with certain examples, various methods may be used to produce the light emitting devices. In some examples, each of the components may be produced using spin coating, spray coating, dip coating, brushing, vapor deposition, layer-by-layer processing, or other thin film deposition methods. The electrodes may each be sandwiched, sputtered, or evaporated onto the exposed surface of another layer or the diffuser. One or both of the electrodes may be patterned. The electrodes of the device may be coupled to am energy source, e.g., a voltage source, by one or more interconnects or electrically conductive pathways. Upon application of the voltage, light may be generated from the device. The device may be produced in a controlled (oxygen-free and moisture-free) environment to reduce or prevent quenching of luminescent efficiency during the fabrication process. In the alternative, the device may be exposed to an inert gas, such as argon or nitrogen, to drive away any oxygen molecules. In some examples, the device may be placed in a sealed housing, optionally containing an inert gas, to prevent oxygen or other molecules from reducing the efficiency of the device.

In accordance with certain examples, a method of providing a light emitting device is disclosed. In certain examples, the method comprises providing a first electrode, a second electrode, and an emissive material between the first electrode and the second electrode, and providing a device to optically couple to the emissive material to pass an emission wavelength of the emissive material and eliminate angular dependence of the emission wavelength. The method may also include applying a voltage across the first electrode and the second electrode of the light emitting device to excite the emissive material for subsequent emission of light.

In accordance with certain examples, a light emitting device comprising a strong microcavity optically coupled to a device to provide a Lambertian emission profile is disclosed. The light emitting device may take any of the configurations disclosed herein or other suitable configurations that will be readily selected by the person of ordinary skill in the art, given the benefit of this disclosure.

In accordance with certain examples, a light emitting device comprising a strong microcavity optically coupled to a device that is constructed and arranged to emit light without any substantial angular color shift is provided. The device may take any of the configurations disclosed herein or other suitable configurations that will be readily selected by the person of ordinary skill in the art, given the benefit of this disclosure.

Certain examples are described in more detail below to further illustrate the novel aspects, features and advantages of the technology described herein.

### EXAMPLE 1

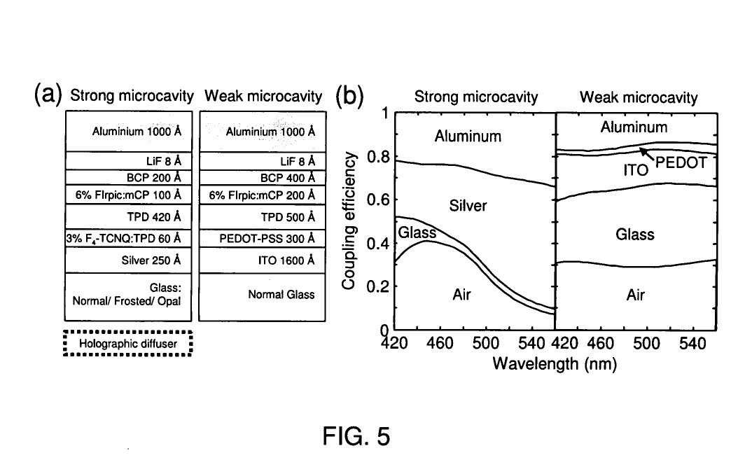

A strong and a weak microcavity OLED structure are compared in FIG. 5(a). The sky-blue phosphor was FIrpic.^{1,7} Devices were grown directly on the smooth back surface of frosted glass and opal glass diffusers. The strong microcavity was designed using analytical calculations of the Poynting vector.⁹ This technique allows the exact determination of the spectral dependence of energy dissipation in each layer within an OLED; see FIG. 5(b).⁹ The holographic diffuser was employed external to devices grown on regular glass. The strong microcavity was formed by an aluminum cathode and a thin silver anode with a doped⁸ hole transport layer to aid hole injection. In the strong microcavity the anode was a thin, semitransparent layer of silver. The cathode was Al/LiF. The electron transport layer was 2,9-dimethyl-4,7-diphenyl-1,10-phenanthroline (bathocuproine or BCP). To aid hole injection from the silver anode, the first 60 Angstroms of the hole transport layer N,N′-diphenyl-N,N′-bis(3-methylphenyl)-[1,1′-biphenyl]-4,4′-diamine (TPD) was doped with 3% by mass of the acceptor tetrafluorotetracyanoquinodimethane (F4-TCNQ). The emissive layer consisted of 6% by mass iridium(III)bis[(4,6-difluorophenyl)-pyridinato-N,C2′]picolinate (FIrpic) in N,N′-dicarbazolyl-3,5-benzene (mCP).

The weak microcavity OLED employed the conventional anode of indium tin oxide (ITO) and PEDOT:PSS rather than silver. The weak microcavity OLED had an anode consisting of indium tin oxide (ITO) and poly(3,4-ethylenedioxythiophene):poly(4-styrenesulphonate) (PEDOT-PSS). Each layer was subject to about 20% uncertainty in the interferometric measure of thickness.

FIG. 5(b) shows the calculated distribution of energy dissipation within the OLEDs. In the strong microcavity OLED, energy lost to the cathode, anode and waveguide modes is labeled, Aluminum, Silver and Glass, respectively. The remaining energy is out-coupled to air. The modeled layers were Ag 250 Angstroms/TPD 650 Angstroms/mCP 135 Angstroms/BCP 270 Angstroms/Al 100 Angstroms. A. In the conventional, or weak microcavity OLED, some energy is dissipated in the aluminum cathode, but most energy is lost to waveguided modes. Roughly 20% of the energy is coupled to waveguide modes in the organic films. These modes are absorbed by the PEDOT and ITO layers. Another 30% is waveguided within the glass substrate. The modeled layers are ITO 1600 Angstroms/PEDOT:PSS 200 Angstroms/TPD 500 Angstroms/mCP 200 Angstroms/BCP 400 Angstroms/Al 1000 Angstroms.

To optimize the color of the strong microcavity OLED, the resonant wavelength is blue-shifted by approximately 20 nm relative to the peak of the intrinsic PL spectrum of FIrpic at 470 nm. At the microcavity resonance, the outcoupling fraction is calculated to be nearly 40%. The energy dissipation within the weak microcavity is also shown for comparison. Its outcoupling fraction to air is calculated to be about 30% and only weakly dependent on wavelength.⁹ At the resonance, the strong microcavity enhances the photonic mode density for photons emitted in the forward hemisphere at the expense of the waveguide modes that dominate in a weak microcavity OLED.⁵ The calculation also shows that most of the remaining energy in the strong microcavity is dissipated in the semitransparent silver layer, suggesting that replacing the silver with a dielectric mirror might further enhance the efficiency.⁵

### EXAMPLE 2

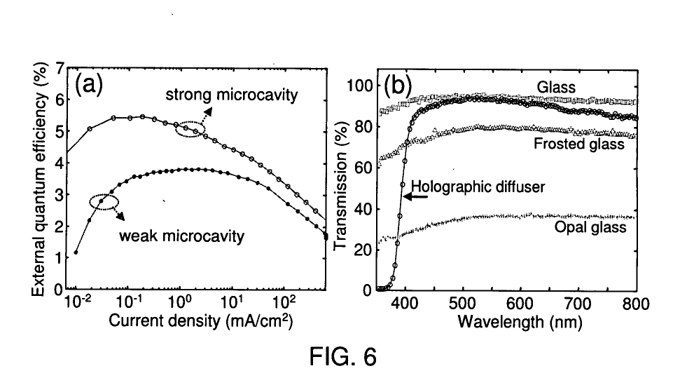

The quantum efficiency of the devices of Example 1 was measured and is shown in FIG. 6(a). Collecting all photons emitted in the forward hemisphere, the peak efficiency for the strong microcavity was (5.5±0.6)%. The efficiency of the weak microcavity OLED was (3.8±0.4)%, smaller than the microcavity result but consistent with the expected modification in the fraction of radiation outcoupled to air. All devices were measured in a nitrogen environment to minimize degradation.

The percent transmission of the OLEDs is shown in FIG. 6(b). Although the strong microcavity enhances the efficiency, optical transmission losses in the scattering filters can be an important source of loss. Three scattering materials were investigated: frosted glass, opal glass and holographic diffusers. ¹⁰ Frosted glass is formed by sandblasting the surface of glass. As shown below, it is the weakest scattering medium and it has only moderate optical transmission. Opal diffusing glass consists of an approximately 0.5 mm-thick white flashed opal film supported on glass. It strongly scatters incident light, but its optical transmission is only 35%. Finally, we characterized holographic diffusers, which are formed by laser patterning the surface of transparent polycarbonate. The holographic diffuser provided the best results; it is a strong scattering medium with an optical transparency of close to 100%.

### EXAMPLE 3

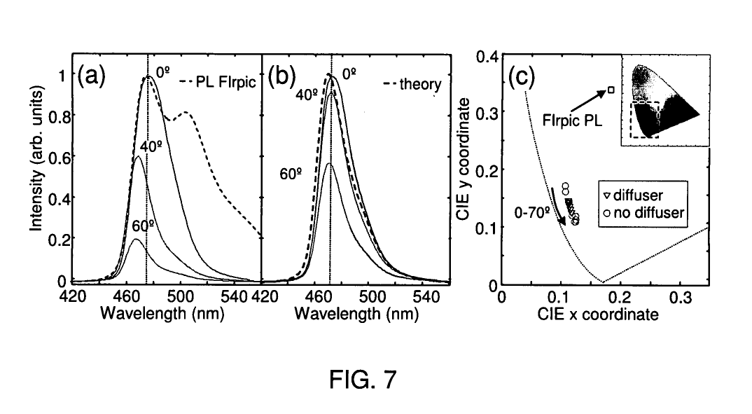

The EL spectra as a function of angle from the surface normal are shown in FIGS. 7(a) and 7(b), for the strong microcavity OLED with (FIG. 7(a)) and without the holographic diffuser (FIG. 7(b)). In FIG. 7(a), the EL spectra of the strong microcavity OLED is compared to the intrinsic PL spectrum of FIrpic. The strong microcavity was observed to strongly suppress the undesirable long wavelength emission. But there was a noticeable color shift with angle. Higher wave numbers are enhanced for large emission angles, yielding a blue shift in the EL spectrum that is constrained only by the sharp high energy shoulder of the FIrpic PL spectrum. With the holographic diffuser, however, the color shift was barely perceptible and compares well to the expected EL spectrum after transmission through an ideal scattering medium. This prediction was obtained from the intrinsic PL spectrum of FIrpic and the calculated strong microcavity outcoupling spectrum from FIG. 4(b). The color coordinates for all devices are shown in FIG. 7(c). The average color coordinates were deep blue (x,y)=(0.116±0.004,0.136±0.010), significantly shifted from the intrinsic PL spectrum of FIrpic: (x,y)=(0.18,0.34). The inset of FIG. 7(c) shows the full CIE diagram identifying the expanded blue region.

### EXAMPLE 4

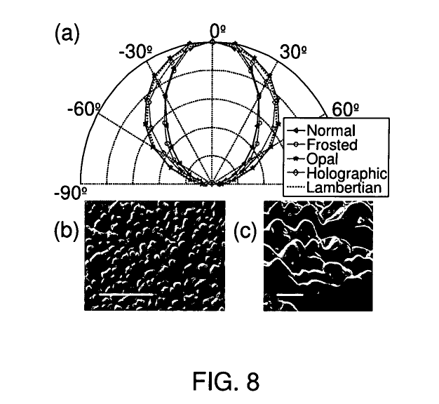

In FIG. 8(a), the angular profile of EL from the strong microcavity OLEDs is plotted. In the absence of scattering, the intensity is maximized normal to the OLED stack, yielding a non-Lambertian emission profile, and potentially causing a large angle-dependent color shift if strong microcavity OLEDs are employed in display applications with conventional green and red Lambertian OLEDs. The addition of a frosted glass filter minimally alters the angular profile slightly. The opal and holographic diffusers, however, are observed to yield near ideal Lambertian profiles, rendering these devices suitable for display applications. In addition, the holographic diffuser has superior optical transparency. Surface and cross sectional scanning electron micrographs of the holographic diffuser are shown in FIG. 8(b)) and FIG. 8(c), respectively. The scattering film is approximately 10 μm thick and lateral surface features are on the order of 5 μm. Provided that the scattering film is placed within about 100 μm of the light emitting device's semi-transparent electrode, a diffuser with similar or smaller feature sizes is appropriate for use in high definition displays.

Certain publications are referred to herein using superscripts and are listed below. The entire disclosure of each of these publications is hereby incorporated herein by reference for all purposes.

1. C. Adachi, R. C. Kwong, P. Djurovich, V. Adamovich, M. A. Baldo, M. E. Thompson, and S. R. Forrest, Appl. Phys. Lett. 79 (13), 2082 (2001).

2. R. 3. Holmes, B. W. D'Andrade, S. R. Forrest, X. Ren, J. Li, and M. E. Thompson, Appl. Phys. Left. 83 (18), 3818 (2003).

3. M. S. Weaver, R. C. Kwong, V. A. Adamovich, M. Hack, and J. J. Brown, J. of Info. Display 14 (5), 449 (2006).

4. T. Tsutsui, N. Takada, S. Saito, and E. Ogino, Appl. Phys. Lett. 65, 1868 (1994).

5. R. H. Jordan, L. 3. Rothberg, A. Dodabalapur, and R. E. Slusher, Appl., Phys. Lett. 69 (14), 1997 (1996).

6. V. Bulovic, V. B. Khalfin, G. Gu, P. E. Burrows, D. Z. Garbuzov, and S. R. Forrest, Phys. Rev. B 58, 3730 (1998).

7. R. J. Holmes, S. R. Forrest, Y.-J. Tung, R. C. Kwong, 3. 3. Brown, S. Garon, and M. E. Thompson, App]. Phys. Left. 82(15), 2422 (2003); FIrpic and mCP were obtained from Luminescence Technology Corp. 2F, No. 21 R&D Road, Science-Based Industrial Park, Hsin-Chu, Taiwan, R.O.C. 30076.

8. W. Y. Gao and A. Kahn, J. Appl. Phys. 94 (1), 359 (2003).

9. K. Celebi, T. D. Heidel, and M. A. Baldo, Optics Express 15 (4), 1762 (2007).

10. Edmund Optics, 101 East Gloucester Pike, Barrington, N.J./USA 08007-1380. The holographic diffusers had a scattering angle profile of 80°.

When introducing elements of the aspects, embodiments and examples disclosed herein, the articles “a, “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

What is claimed is:

1. A light emitting device comprising an emissive material optically coupled to a device that is effective to pass an emission wavelength of the emissive material and eliminate angular dependence of the emission wavelength.

2. The device of claim 1, in which the light emitting device comprises a first electrode and a second electrode, and the emissive material is between the first electrode and the second electrode.

3. The device of claim 2, in which the composition of each of the first electrode and the second electrode is selected to provide a strong microcavity.

4. The device of claim 3, in which the composition of each of first electrode and the second electrode provides a reflective film.

5. The device of claim 3, in which the composition of the first and second electrodes is independently selected from the group consisting of aluminum, silver, gold and combinations thereof.

6. The device of claim 1, in which the device optically coupled to the emissive material is an opal diffuser or a holographic diffuser.

7. The device of claim 1, in which the emissive material is a phosphor.

8. The device of claim 2, further comprising a hole transport layer between the first electrode and the emissive material.

9. The device of claim 8, in which the hole transport layer is doped with tetrafluorotetracyanoquinodimethane.

10. The device of claim 9, in which the composition of each of the first electrode, the second electrode and the doped hole transport layer is selected to provide a strong microcavity.

11. The device of claim 2, further comprising an electron transport layer between the second electrode and the emissive material.

12. The device of claim 8, further comprising an electron transport layer between the second electrode and the emissive material.

13. A method of proving a light emitting device comprising:
providing a first electrode, a second electrode, and an emissive material between the first electrode and the second electrode; and
providing a device to optically couple to the emissive material to pass an emission wavelength of the emissive material and eliminate angular dependence of the emission wavelength.

14. The method of claim 13, further comprising applying a voltage across the first electrode and the second electrode of the light emitting device to provide emission from the emissive material.

15. The method of claim 13, further comprising configuring the first electrode to be biased by an energy source to provide electrons.

16. The method of claim 13, further comprising providing an electron transport layer between the first electrode and the emissive material.

17. The method of claim 13, further comprising providing a hole transport layer between the second electrode and the emissive material.

18. A light emitting device comprising
a first electrode;
a second electrode;
an emissive material disposed between the first electrode and the second electrode; and
a device optically coupled to the emissive material and configured to pass an emission wavelength from the emissive material that is substantially independent of viewing angle.

19. The device of claim 18, in which the composition of each of the first electrode and the second electrode is selected to provide a strong microcavity.

20. The device of claim 19, in which the composition of the first and second electrodes is independently selected from the group consisting of aluminum, silver, gold and combinations thereof.

21. The device of claim 18, in which the device optically coupled to the emissive material diffuser is an opal diffuser or a holographic diffuser.

22. The device of claim 18, in which the emissive material is a phosphor.

23. The device of claim 18, further comprising a hole transport layer between the first electrode and the emissive material.

24. The device of claim 23, in which the hole transport layer is doped with tetrafluorotetracyanoquinodimethane.

25. The device of claim 24, in which the composition of each of the first electrode, the second electrode and the doped hole transport layer is selected to provide a strong microcavity.

26. The device of claim 18, further comprising an electron transport layer between the second electrode and the emissive material.

27. The device of claim 23, further comprising an electron transport layer between the second electrode and the emissive material.

28. A light emitting device comprising a strong microcavity optically coupled to a device to provide a Lambertian emission profile.

29. A light emitting device comprising a strong microcavity optically coupled to a device constructed and arranged to emit light without any substantial angular color shift.
